(19) United States
(12) Patent Application Publication
(10) Pub. No.: US 2009/0138607 A1
(43) Pub. Date: May 28, 2009

(54) Method and System for Enabling Multipart Communication in a Computer Network

(75) Inventor: Magnus Ossiansson, Tystberga (SE)

Correspondence Address: DICKSTEIN SHAPIRO LLP, 1825 EYE STREET NW, Washington, DC, 20006-5403, US

(73) Assignee: COSTREAM AB, LINKOPING (SE)

(21) Appl. No.: 11/922,393

(22) PCT Filed: Jun. 22, 2005
(86) PCT No.: PCT/SE2005/000985

§ 371 Date: May 2, 2008

(51) Int. Cl. G06F 15/16

(52) U.S. Cl. 709/228

(57) ABSTRACT

The present invention relates to a method for enabling multipart communication between computers 1a, 1b, . . . , in of at least two users belonging to a session. The computers have access to a computer network, such as an internet/intranet and the method is characterised by the steps of: creating session information 4, including a session identification and information such as user identities, time stamps and different commands; storing the session information 4 in a data storage means 2 accessible for the users; and providing means for enabling the users to retrieve information from said session information 4 and/or to enter information to said session information 4, whereby commands may be retrieved by each-user and be executed on their respective computers 1a, 1b, . . . , 1n. The invention also relates to a system for performing said method.

### FIELD OF THE INVENTION

The present invention relates to a method for enabling multipart communication between computers of at least two users belonging to a session, of the kind apparent from the attached claim 1, and a system for performing said method, of the kind apparent from the attached claim 10.

### BACKGROUND OF THE INVENTION

There are many applications in which communication between computers is an essential part. For example, surfing the Internet is becoming an ever increasingly popular occupation for many people, both as a tool in their professional work and as a pastime in their spare time. This requires communication between computers, interconnected somehow. Simultaneous co-surfing on the Internet among several persons is also becoming more and more popular, it is for example possible for several people to participate in and play a network game simultaneously though being located at different locations and thus using different computers.

There are however several drawbacks with the presently available methods for simultaneously surfing the Internet, or some other kind of collaboration and communication between users of different computers. One major problem with prior art methods is that the users, who, for example, wishes to surf the same pages on the Internet simultaneously have to install software into their computer, allowing this “co-surfing”. For example, a person wishing to play a certain network game has to install a special program for enabling communication with the other participants. This downloading of programs is a major drawback for several reasons; firstly it takes up space on the hard disk, space which may not always be available. Secondly, not all users are allowed to install programs, but has to contact a data support, and thirdly troubles with the fire wall may arise when installing such communication programs. Further, problems may arise in the updating procedure between the different participants; it is most often difficult to perform these updates.

U.S. Pat. No. 6,430,567 describes one such prior art method for enabling collaboration between users of computer systems, in which method software is installed in the user's computer. The described method makes use of collaboration applets (i.e. a Java program which can be distributed as an attachment in a WWW document and executed by a Java-enabled web browser) executed in the user's computer. Thereby the method described in this document embraces the above described disadvantages. The user may for example encounter difficulties in the communication, since many firewalls block the downloading of applets.

### SUMMARY OF THE INVENTION

An object of the present invention is to provide a method and system for enabling multipart communication between computers, enabling, for example, several users to co-navigate in a computer network simultaneously, in a convenient and easy manner. More specifically, it is an object of the present invention to provide a method and system for enabling multipart communication between several people's computers, overcoming any accompanying problems in the multipart communication due to the different user's fire walls.

An additional object is to provide a method and a system for enabling such multipart communication between computers without the need to install software in the user's computer.

These objects are achieved, according to a first aspect of the present invention, by a method as claimed in claim 1. The present invention thus provides a method for enabling multipart communication between computers of at least two users belonging to a session, said computers having access to a computer network. The method comprises the steps of: creating session information, including a session identification and information such as user identities, time stamps and different commands; storing said session information in a data storage means accessible for the users through the computer network; providing means for enabling the users to retrieve information from said session information and/or to enter information to said session information, whereby commands may be retrieved by each user and be executed on their respective computers. Thereby the users may retrieve communication information from an external data storage means, such as a server computer, and there is no need to install any software in the respective computers.

In accordance with one embodiment of the present invention, said means for retrieving and entering information comprises a script stored on a webpage accessed by the users. Thereby the script receives instructions from the users and puts these instructions, preferably along with time stamps of reception, in the session file accessible for all users. The script also provides information to the web browsers used by the computers for finding said session file. The users may thus easily retrieve the latest instructions and perform these on their respective computers. The instructions may further be performed simultaneously on the respective user's computers.

In accordance with another embodiment of the present invention, said script is a JavaScript or a Visual Basic Script. These scripts are advantageous in that no program need to be installed in a user's computer in order to be used, an ordinary web browser suffices.

In accordance with another embodiment of the present invention the method further includes the step of defining at least one of said at least two users, as an active user permitted to update said session information, and having the at least one other user retrieving updated information from said session information. Thereby said at least one other user receives updated time stamps and related commands, which commands are executed on the respective computers. It may be advantageous to let some users have the right only to retrieve the information, and not the right to alter it, since thereby one user may guide the rest of the users easily and conveniently.

In accordance with another embodiment of the present invention said communication is performed exclusively via the 80 port. This is advantageous in that the users thereby have no problems with the communication due to fire walls, when accessing the Internet.

In accordance with another embodiment of the present invention said commands comprises directions for enabling simultaneous surfing on the computer network, said directions comprising the movements of a user's insertion pointer, whereby the same movements are executed on the other user's computers. This enables several users to surf the same pages simultaneously, preferably by having one user guide the others. The commands, or instructions, may further include text messages enabling chatting, audio and video enabling real-time video conferencing, changes to a document enabling simultaneous editing of the document among several users. The invention thus provides several possible applications.

In accordance with another embodiment of the present invention said session information (4) is in the format of a HTML-file, a XML-file, a text-file, a JSP-file or an ASP-file. All these file formats may be passed through the 80-port, whereby possible troubles with fire walls are avoided.

The invention also comprises a system for performing said method, whereby similar advantages are achieved.

### BRIEF DESCRIPTION OF THE DRAWINGS

FIG. 1 shows a schematic view over the system in accordance with the present invention.

FIG. 2a schematically shows the contents of a data storage means, used in the present invention.

FIG. 2b shows an illustrative example of a login-procedure in accordance with the present invention.

FIG. 3 shows a flow chart over the different steps performed in a method in accordance with the present invention.

### DETAILED DESCRIPTION OF PREFERRED EMBODIMENTS

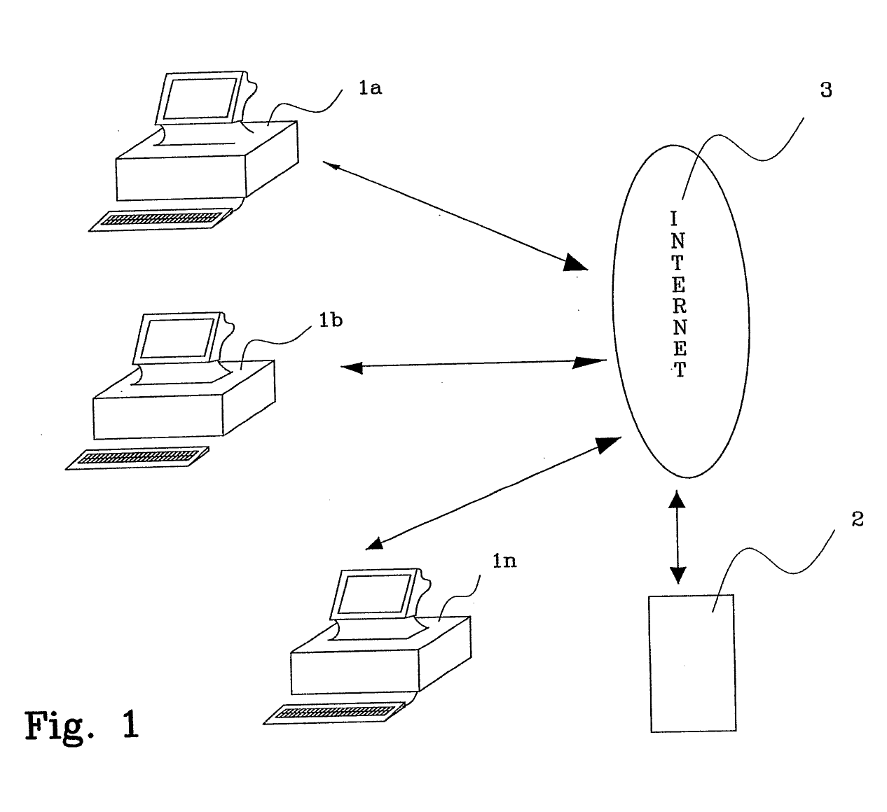

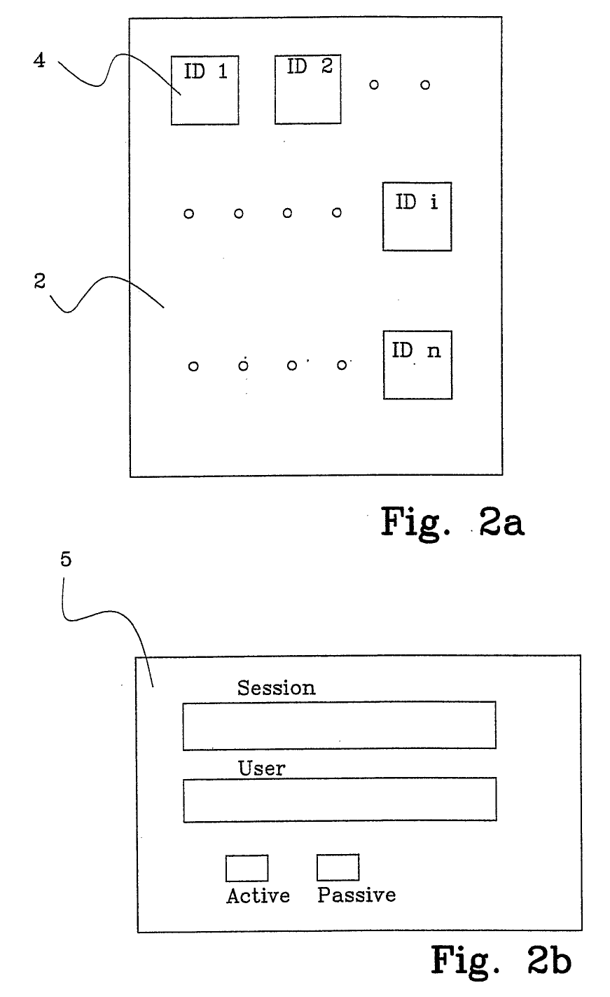

With reference first to FIG. 1, the basic structure of the present invention will be explained. Several computers 1a, 1b, . . . , in are all enable to access an internet 3, for example the Worldwide Web (WWW), i.e. any set of networks interconnected with routers, in a well known manner. There is provided some kind of data storage means 2, which for example may be a server computer connected to the internet. In accordance with the invention, the data storage means 2 contains different session files 4, which session files will be described more in detail later, in connection with FIGS. 2a and 2b.

In accordance with the present invention, no programs need to be installed in the computers 1a, 1b, . . . , 1n of the user's in order to enable communication between the users. The only two requirements are that the computers 1a, 1b, . . . , 1n are provided with a page reader, for example a web browser, allowing the user to read HTML (Hypertext Markup Language) documents, and that the computers 1a, 1b, . . . , in are able to handle for example JavaScripts (which most web browsers are able to) or Visual Basic script or the like.

It is well known that internet communication between computers is performed in accordance with a protocol called TCP/IP (Transmission Control Protocol/Internet Protocol), and, on a transport level, in accordance with HTTP (Hypertext Transfer Protocol). The TCP/IP is thus used on the WWW for the exchange of HTML documents. Each application program has a unique port number associated with it; HTTP, for example, uses port 80. The invention may be used in any kind of computer network, such as several computer networks interconnected (internet), or just one computer network (internally), such as an intranet.

HTTP data packets are adapted to pass through firewalls protecting client computers 1a, 1b, . . . , 1n and the data storage means 2, for example a server computer. The present invention uses this fact in order to update communication information between the different users in a simple and effective way.

In accordance with one embodiment of the invention, a script or some other program enabling the inventive way for communication between users, is included on a webpage. The script is written in a scripting language such as for example JavaScript or Visual BASIC Script. Simply stated, the function of the script/program is to request, or direct, the web browser's of the different users to read a special session file 4, belonging to the session in question. Web browsers may encounter difficulties in reading the session file 4 if the script is not located on the same server as the web page in question, it is therefore preferred that said script is included on a webpage. The script may however, in another embodiment of the invention, be placed separately from the webpage.

With reference now to FIG. 2a, the data storage means 2 is shown containing different such session files 4, each having a unique session identification (session ID), ID 1, ID 2, . . . , ID n. The session files 4 are created by means of a script or program enabled to (i.e. having the rights to) write on the hard disc of the server. The session file 4 contains information provided by active users (users having the right to both read and write to a session file 4) participating in the session, such as for example information about the users, time stamps and incoming and outgoing commands. A passive user may only retrieve (read) said information. Session files 4 may be created by a user when needed, or they may be predefined and pre-stored in the data storage means 2. This script may then be called by the user's web browsers. The script or program on the server-side creating and updating the session files 4 may for example be cgi or jsp programs, or similar programs that may easily be called by the web browsers on the client side.

Each user (or rather, each user's web browser) need to know the name of the session file 4 and where to find it, i.e. the location of the session file 4 (for example an URL, Uniform Resource Locator, or the like, identifying the storage location of the file), which information is provided by said script. An example of a write call (an action being performed by an active user) is as follows:

Puchf=window.open(“http://www.panograf.com/CoBrowse/cobrowse.jsp?id=session5&data=dosync [symbol] 5 [symbol] 336 [symbol] 253 [symbol] 9”, “push”);

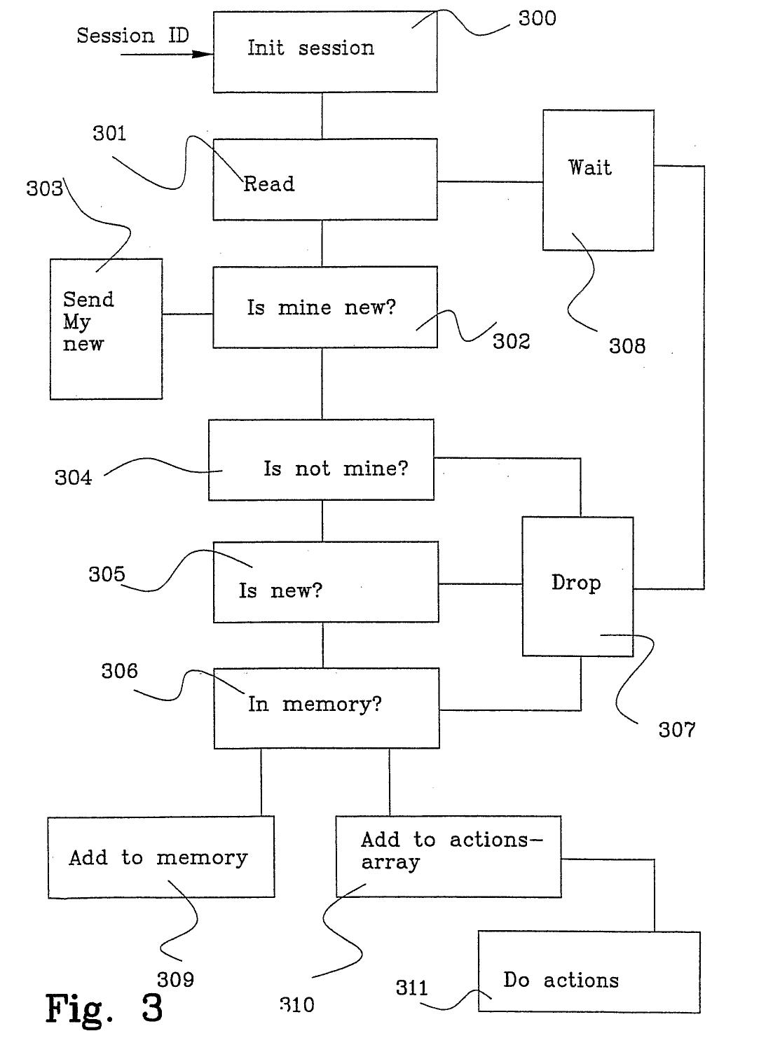

As is recognized by a person skilled in the art, the puchf=window.open command is a javascript command for opening a window. Cobrowse.jsp is in this example a jsp-program located on the website at the specified URL. The script or program retrieves (filters out) the session file 4 for the current session, said session file 4 being denoted “session5.htm”, and including the command dosync [symbol] 5 [symbol] 336 [symbol] 253 [symbol] 93, a command synchronising the participants. This part of the search string contains all of the contents of the session file 4, and possibly new commands (in the example the synchronising command is the first and thus so far the only command). The read/write procedure will be explained more in detail later, with reference to FIG. 3.

The computers of the participants are able to handle for example Javascripts, as the script preferably is written in a scripting language such as JavaScript or Visual BASIC Script, and is used in order to filter out information retrieved from the session file 4. However, such filtering operations may in an alternative embodiment of the present invention be performed on the server-side by the script or program that writes the commands to the session file 4. The filtering tasks may also, in yet another embodiment, be divided between the server-side script and the client-side script handling units. For example, having the server-side handle time synchronizations may be advantageous in that the clients (client computers) need not be synchronised at all. It is pointed out that JavaScript is only very vaguely related to Java; the use of JavaScript does not require the installation of Java on the computer. The script may be called in a number of ways, it may be opened in a new window, a frame, i-frame (integrated frame) or the like. The information, if any, is sent in the call itself.

Each respective session file 4 corresponds to a particular session set up by an active user. As mentioned above, a user may have the right to read and write to a session file 4, which user is then defined to be an active user (in the example given above, an active user is authorised to write the exemplifying synchronising command to the session file 4), or the user may have the right to only read information from the session file 4, in which case the user is defined to be a passive user (again, in the example given above, a passive user would only be allowed to retrieve the synchronising command, not write commands to the session file 4 himself). The session file 4 may be opened by the user (client computer) or by the serverside script, as a HTML-file, a XLM-file, a text-file, a JSP or ASP-file or the like. All these file formats use the HTTP port (port 80), and the user will thus have no problems with fire walls, if present.

The session file 4 contains, besides the session identification, identifying the session in question, time stamps, for synchronising the different users. As was mentioned above, this synchronisation can be accomplished in a number of ways; the time may for example be synchronised after the computer of a particular user (e.g. the one who initiates the session). The synchronization may thus be performed either on the client-side or the server-side. If the session is set up in order for an active user to guide a number of passive users through the pages of a web site, the movements of the insertion pointer of the active user are transferred to the session file 4 along with the time stamps of each movement. The computers 1a, 1b, . . . , 1n of the passive users retrieve this information and the commands are executed on their respective computers 1a, 1b, . . . , 1n. Thereby the active user may guide the others through the pages in a co-navigating manner. The time stamps are derived from one user only, in order for the users to be synchronised. All the participants of a certain session continuously retrieve updated information, for example every fifteen seconds.

If there are more than one active user of a session, there is provided a queue for the input commands, or control commands, from these active users, since usually only one command can be executed at a time. The active users may have different priorities, for example giving one of them the right to override the commands of others.

In some applications it may be beneficial to have a login procedure in order for a user to be allowed to participate in a particular session. An example of a login window is shown in FIG. 2b. The user may enter a session ID, identifying the session file 4 and thus the session he or she wishes to participate in. The user may then be prompted to enter an user identification. The data storage means 2 may include a user register, in which user information is stored. This would facilitate the login procedure, and the information may for example include the name of the user along with an e-mail address of the user, IP-numbers and the like. Lastly the user may be prompted to state whether he or she is an active or passive user. This may not be required in all instances; the information may for example be stored in the data storage means 2 as part of the user information if the user always is an active user or a passive user. The login procedure is not essential for the invention, and not even compulsory. There may also be a password requirement, for enhancing the security, if needed, preventing unauthorised persons to participate.

With reference now to FIG. 3, the method in accordance with the present invention will be described more in detail. FIG. 3 shows how a web browser implementing the present invention operates, when making calls to the session file 4. Firstly a session ID has to be provided, pointing out the correct session file 4, whereupon the session is initiated, step 300. In step 301 the web browser reads the session file 4, and in step 302 a comparison is made between the copy of the session file 4 stored in the web browser and the actual session file 4. If the user is an active user and has the right to write to the file, there might be changes to the session file 4, which changes in that case are read to the session file 4. There might also be changes (for example a new instruction) to the session file 4 if other users are active users and also has the right to write to the session file 4. In the former case, step 302, it is determined whether the particular user's latest changes are made, and if not, they are sent to the session file 4 in step 303. If the particular user's latest changes already are present in the session file 4, it is determined whether other users have made changes to the session file 4, step 304. If no changes are detected, the process continues to step 307 and step 308, where the process is started over. If there are changes made by other users, the process continues to step 305, where it is checked whether the changes are sufficiently recent, as determined by a predetermined period of time, for example less than 30 seconds old. If the changes are too old the process again proceeds to step 307 and 308, but if the changes are new, i.e. sufficiently recent, the process continues to step 306. In step 306 it is determined whether the changes (e.g. new instructions) are in the memory of the user's computer. If yes, the process continues to step 307 and 308, else the changes (instructions) are added to the memory in step 309 and to an actions array in step 310. Thereafter the instruction(s) is/(are) executed. If the user is a passive user, i.e. only has the right to read the session file 4 and not write to it, the process may be simplified, as steps 302-304 may be omitted.

Preferably the read and write processes, respectively, are performed in parallel, but a sequential execution is also possible. If a sequential execution is implemented additional steps may be needed; a check-up should be made as to whether a process is running or not, and if yes, the new process is put on hold until the process already running is finished.

A synchronisation feature may further be provided, in which it is determined whether all users are synchronised, not in a time synchronisation, but in the sense that they all have executed the same set of instructions. This may be accomplished by having the users verify not only their own respective commands, but also that all the other users have executed the instructions on the session file 4. An active user may for example have access to a “synchronisation button”, and when depressing the button all users are synchronised and thus the latest executed instruction is the same for all users.

The invention may be used for example in situations where a user finds a web page to be difficult to navigate on by himself and needs a guide, in chat applications, in video conference applications, for educational purposes, for enabling simultaneous editing of documents, for support services or as a demonstration facility. In short, the present invention is useful in all kinds of different applications, in which users need to communicate information between each other. It is thus realised that the principles of the present invention may be used in a variety of communication applications.

The co-navigation application is described somewhat more in detail in the following. For example, when an active user uses his or hers mouse, the corresponding movements are converted into pairs of coordinates defining said movements. These are sent as instructions to the session file 4, where they may be retrieved by the other participant's web browsers. The passive users may thus see on their respective computer screens (or the like) all the pages, views and possibly other events performed by the active user. Other events besides the movements of a mouse may of course also be converted into commands correspondingly performed on the respective computers, such as for example the actions executed upon the depression of buttons on a mouse.

A specific example will now be described, in which the present invention may be used. A real estate agent may want to show a certain object, for example a house on sale, simultaneously to several people interested in the object. The real estate agent creates a session file 4 having a session identification (session ID) stored in a data storage means 2 and specifying the session to be set up. The real estate agent then gives the interested parties an address to a start page on the WWW (World Wide Web), for example the website of the real estate company. The agent further provides the interested parties with the session ID for the session in which the specific object is to be shown. All the users, including the agent, may login to this session, by entering the session ID, a user name and also a user status. The user status is a two choice alternative; either the user is a passive participant or else an active participant, as was explained above. Preferably the agent then is an active user, whereas the interested parties all are passive users. A person being active has the permission and ability to guide the other users, and a person being a passive user may only passively watch. The real estate agent then guides the interested parties through the object: 3D pictures constituting a real time movie of the house on sale may be stored and retrieved in connection with the session. The agent may, in the capacity of being an active user, use a mouse connected to his computer in order to guide the other users through the house (as was explained above). As the real estate agent moves the mouse for example to the left, a view of the house moves to the left. This is where the present invention comes into use, since the other users now have to be updated of the moves and actions made by the real estate agent. The real estate agent being an active user entails him being authorised to edit the session document, and the moves he makes are transferred to the session file 4, for example in accordance with the flow chart of FIG. 3. The updates made to the session file 4 are continuously monitored by the passive users, and they retrieve the updates regularly, whereby the moves (or events) made by the real estate agent are performed almost simultaneously on the screens of all the other (passive) users. The session may of course also include voice capabilities, by means of which the real estate agent is enabled to orally describe the house.

The present invention may also be used in an intranet, for example for educational purposes. The users of the intranet may use the present invention in order to start a display show (for example using powerpoint), or any other co-navigation in the intranet.

In summary, the present invention provides a method for enabling communication between computers solely by means of calls or invocation procedures. The present invention thus eliminates the need for establishing secure connections between the computers intended for communication, and no installations of additional software is required.

Thus, while the invention has been described with reference to particular embodiments, it is to be understood that this invention is not limited to the particular forms illustrated. Modifications obvious to a person skilled in the art are to be included within the scope of the appended claims.

1. A method for enabling multipart communication between computers (1a, 1b, . . . , 1n) of at least two users belonging to a session, said computers having access to a computer network, wherein the method is characterised by the steps of:
creating session information (4), including a session identification and information such as user identities, time stamps and different commands,
storing said session information (4) in an external data storage means (2) accessible for the users through said computer network,
providing means for enabling the users to retrieve information from said session information (4) and/or to enter information to said session information (4), whereby commands are retrieved by each user and executed on their respective computers (1a, 1b, . . . , 1n).

2. Method as claimed in claim 1, characterised in that said means for retrieving and entering information is performed by means of a web browser.

3. Method as claimed in claim 1, characterised in that said means for retrieving and entering information is performed by means of a script stored on a webpage accessed by the users.

4. Method as claimed in claim 3, characterised in that said script is a clientside script, such as JavaScript or a Visual Basic Script.

5. Method as claimed in claim 1, characterised in the further step of:
defining at least one of said at least two users, as an active user permitted to update said session information (4),
having the at least one other user retrieving updated information from said session information (4), whereby said at least one other user receives said updated time stamps and related commands, which commands are executed on the respective computers (1a, 1b, . . . , 1n).

6. Method as claimed in claim 1, characterised in that said computers have access to an internet and/or intranet and that said retrieval and entering of information to said session information (4) is performed exclusively via the 80 port.

7. Method as claimed in claim 1, characterised in that said commands comprises one or more of: directions for enabling simultaneous navigation on a website, said directions comprising events, for example corresponding to the movements of a user's insertion pointer, whereby the same events are executed/shown on the other user's computers.

8. Method as claimed in claim 1, characterised in that said commands comprises one or more of: text messages enabling chatting, audio and video enabling real-time video conferencing, changes to a document enabling simultaneous editing of the document among several users.

9. Method as claimed in claim 1, characterised in that said session information (4) is in the format of a HTML-file, a XML-file, a text-file, a JSP-file or an ASP-file.

10. A system for enabling multipart communication between computers (1a, 1b, . . . , 1n) of at least two users belonging to a session, said computers having access to a computer network, wherein the system is characterised by:
means for creating session information (4), including a session identification and information such as user identities, time stamps and different commands,
means storing said session information (4) in an external data storage means (2) accessible for the users,
means for enabling the users to retrieve information from said session information (4) and/or to enter information to said session information (4), whereby commands are retrieved by each user and executed on their respective computers (1a, 1b, . . . , 1n).
